(19) United States
(12) Patent Application Publication
(10) Pub. No.: US 2014/0062386 A1
(43) Pub. Date: Mar. 6, 2014

(54) SENSOR SHARING FUEL GAUGE

(71) Applicants: Gregory A. Maher, Cape Elizabeth, ME (US); Oscar W. Freitas, Cape Elizabeth, ME (US); Travis Williams, Scarborough, ME (US)

(72) Inventors: Gregory A. Maher, Cape Elizabeth, ME (US); Oscar W. Freitas, Cape Elizabeth, ME (US); Travis Williams, Scarborough, ME (US)

(73) Assignee: Fairchild Semiconductor Corporation, San Jose, CA (US)

(21) Appl. No.: 13/603,632

(22) Filed: Sep. 5, 2012

(51) Int. Cl. G01K 13/00; H02J 7/00; G01K 1/02

(52) U.S. Cl. 320/107; 374/142; 374/E13.001; 374/E01.002

(57) ABSTRACT

A fuel gauge can include a resistor configured to generate predetermined temperature information and a switch configured to couple a temperature sensor to a temperature output of the fuel gauge in a first state and to couple the resistor to the temperature output of the fuel gauge in a second state.

### BACKGROUND

As users become more dependent on mobile computing devices, electric vehicles, or other cordless tools, the operational status of these devices, such as the state of charge of the battery or fuel cell, has become increasingly important to the users.

### OVERVIEW

A fuel gauge can include a resistor configured to generate predetermined temperature information and a switch configured to couple a temperature sensor to a temperature output of a fuel gauge in a first state and the resistor to the temperature output of the fuel gauge in a second state.

This section is intended to provide an overview of subject matter of the present patent application. It is not intended to provide an exclusive or exhaustive explanation of the invention. The detailed description is included to provide further information about the presen patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a system including an example fuel gauge.

### DETAILED DESCRIPTION

With increased user reliance on mobile electronic devices, such as mobile computing devices, mobile phones, electric vehicles, cordless tools, etc., users are more keenly aware of the benefit of accurate status of the state of charge of the mobile computing device's energy storage device. Many mobile devices include a fuel gauge that can indicate the state of charge of an energy storage device, such as a battery, a fuel cell, etc. Energy storage devices often include a temperature sensor, such as a thermistor, to provide temperature information about the energy storage device. The temperature information can be used by a charging device to quickly, efficiently, or properly charge or recharge the energy storage device. Energy storage device temperature information can also be used by the fuel gauge to determine accurate state of charge information about the energy storage device,

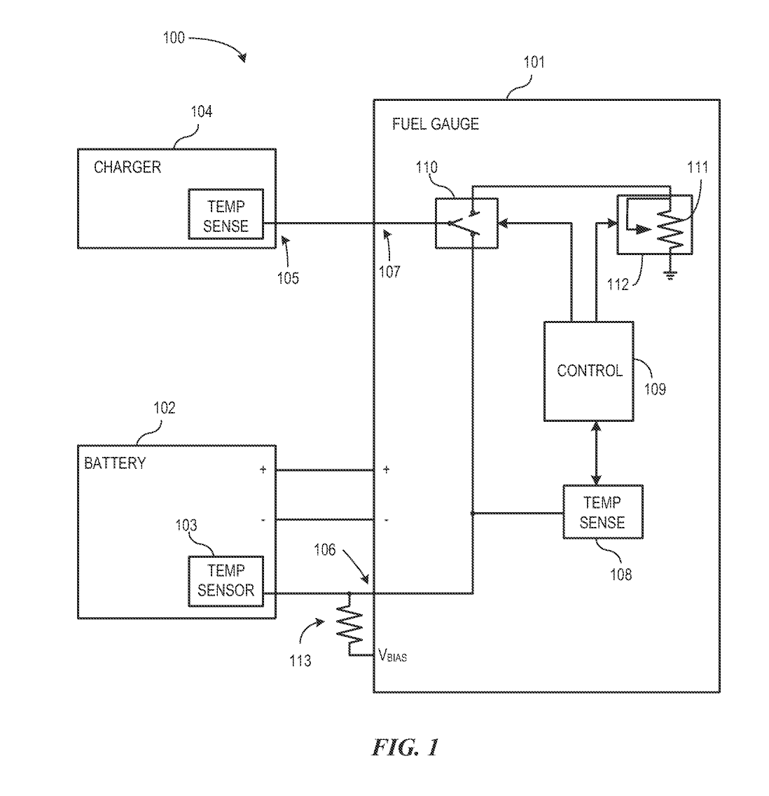

FIG. 1 illustrates generally a system 100 including an example fuel gauge 101. In certain examples, the system 100 can include an energy storage device (e.g., a battery 102), a temperature sensor (e.g., a thermistor 103), a charger 104 having a temperature sensor input 105, and the fuel gauge 101. The fuel gauge 101 can include a sensor input 106, a sensor output 107, a temperature sense module 108, and a control module 109. In an example, the sensor input 106 can receive temperature information from the battery 102. The sensor output 107 can provide temperature information to the charger 104. In some examples, the temperature sense module 108 can process the temperature information from the battery 102 and provide the processed temperature information to the control module 109, The control module 109 can further process the temperature information and can provide display information for providing an indication of a state of charge of the battery 102, for example, to an external display for a user. In certain examples, the sensor input 106 can be coupled to the sensor output 107 to pass the temperature information from the temperature sensor (e.g., the thermistor 103) to a device other than the fuel gauge 101, such as to the charger 104. In certain examples, the temperature sensor (e.g., the thermistor 103) can be coupled to the charger 104 via the fuel gauge 101. In such examples, the temperature sense module 108 can have a very high impedance in contrast to the impedance at the sensor output 107), such that the temperature sense module 108 does not significantly distort the temperature information provided to the sensor output 107.

In certain examples, the fuel gauge 101 can include a switch 110 and a device configured to provide predetermined temperature information, such as a resistor 111. In an example, the fuel gauge can include the temperature sense module 108 and the control module 109.

The switch 110 can be configured to couple the sensor input 106 to the sensor output 107 in a first state and can be configured to isolate the sensor output 107 from the sensor input 106 in a second state. In some examples, the switch 110 can default to the first state when no power is applied to the fuel gauge 101.

In an example, the switch 110 can couple the resistor 111 to the sensor output 107 in the second state. In some examples, the switch 110 can include a transistor configured to couple the sensor input 106 to the sensor output 107. In an example, the switch 110 can include a depletion-mode transistor such that when no power is applied to the fuel gauge 101 the sensor input 106 can be coupled to the sensor output 107.

In certain examples, the fuel gauge 101 can allow temperature information of the battery 102 to be shared with the fuel gauge 101 and the charger 104, or a charger circuit, such as a charger integrated circuit (IC). In some examples, the temperature information of the battery 102 can be shared seamlessly between the fuel gauge 101 and the charger 104 without additional external devices or software.

In certain examples, the filet gauge 101 can include more than one temperature input and can share temperature information from the more than one temperature input between the charger 104 and the fuel gauge 101.

In certain examples, the control module 109 can cycle the switch 110 to share the temperature information at the sensor input 106 with the sensor output 107 and the fuel gauge 101. In some examples, the charger 104 coupled to the sensor output 107 can use the battery temperature information to efficiently or effectively charge the battery 102. In some examples, the fuel gauge 101 can use the battery temperature information to provide accurate state of charge information of the battery 102.

The resistor 111 of the fuel gauge 101 can be coupled to the sensor output 107 to temporarily provide predetermined temperature information to the sensor output 107, for example, for the charger 104, to minimize disruption to a charging process. In certain examples, the control module 109 can cycle the switch 110 between the first and second states at a predetermined duty cycle. In some examples, the duty cycle for the first state can be between about 50% and about 90%. The higher duty cycle can provide the most consistent temperature information to a charger circuit coupled to the sensor output 107. The lower duty cycle can provide more consistent temperature information to the fuel cell for improved state of charge information. In certain examples, the resistor 111 can include a programmable resistor 112. In some examples, the programmable resistor 112 can be programmed to provide temperature information corresponding to a particular temperature, for example, a temperature representative of an average operating temperature of the battery 102. In some examples, the control module 109 can program the programmable resistor 112 to provide temperature information representative of the temperature information available at the sensor input 106. In certain examples, the control module 109 can update the setting of the programmable resistor 112 at each cycle or each N number of cycles, where N is an integer.

In certain examples, the control module 109 can cycle the switch 110 at a predetermined frequency. In certain examples, the frequency can be less than 2 Hertz (Hz), In some examples, the frequency can be 10 Hz or less, In some examples the frequency can be above 10 Hz. Lower cycle frequency can be used to conserve processing power for applications where rapid temperature change is not an issue. Higher cycle frequency can be used in applications where timely, accurate temperature and state of charge information is beneficial.

In certain examples, as an option, the fuel gauge can include a bias resistor 113 coupled to the sensor input 106. A bias voltage (V_{BIAS}) can be applied to the bias resistor 113 to provide a proper voltage bias for the temperature sense module 108 of the fuel gauge 101. In some examples, the value of the bias resistor 113 can be equal to the resistance value of the battery temperature sensor 103 at a given ambient temperature, for example, at room temperature or about 25° Celsius. It is understood that other bias methods are possible without departing from the scope of the present subject matter including, but not limited to, applying a bias current to the sensor input 106. In certain examples, the bias resistor 113 is part of a fuel gauge integrated circuit including the temperature sense module 108. In certain examples, the bias resistor 113 can be external to the fuel gauge integrated circuit. In some examples, the bias resistor 113 is adjustable. In some examples, the bias resistor 113 is programmable,

### Additional Notes

In Example 1, a fuel gauge can include a resistor configured to generate predetermined temperature information and a switch configured to couple a temperature sensor to a temperature output of the fuel gauge in a first state and to couple the resistor to the temperature output in a second state.

In Example 2, the switch of Example 1 is optionally configured to default to the first state when no power is applied to the fuel gauge.

In Example 3, the switch of any one or more of Examples 1-2 optionally includes a transistor.

In Example 4, the switch of any one or more of Examples 1-3 optionally includes a depletion-mode transistor.

In Example 5, the resistor of any one or more of Examples 1-4 optionally includes a programmable resistor.

In Example 6, the fuel gauge of any one or more of Examples 1-5 optionally includes a temperature sense module having an input coupled to the switch and configured to receive information from the temperature sensor.

In Example 7, the fuel gauge of any one or more of Examples 1-6 optionally includes a bias resistor configured to provide a bias voltage to the temperature sense module,

In Example 8, the fuel gauge of any one or more of Examples 1-7 optionally includes a control module configured to cycle the switch between the first state and the second state with a predetermined duty cycle.

In Example 9, the switch of any one or more of Examples 1-8 optionally is configured to isolate the temperature output from the temperature sensor in the second state.

In Example 10, a method of fuel gauge control can include coupling a temperature sensor to a temperature output of a fuel gauge using a switch in a first state, generating predetermined temperature information using a resistor, coupling the resistor to the temperature output of the fuel gauge using the switch in a second state, and wherein the fuel gauge includes the switch and the resistor.

In Example 11, the method of any one or more of Examples 1-10 optionally includes defaulting the switch of the fuel gauge to the first state when no power is applied to the fuel gauge.

In Example 12, the method of any one or more of Examples 1-11 optionally includes receiving temperature information from the temperature sensor at a temperature sense module, wherein the fuel gauge can include the temperature sense module,

In Example 13, the method of any one or more of Examples 1-12 optionally includes cycling the switch between the first state and the second state with a predetermined duty cycle.

In Example 14, the predetermined duty cycle of any one or more of Examples 1-12 optionally includes a duty cycle of the first state that is at least twice a duty cycle of the second state,

In Example 15, the coupling the resistor to the temperature output using the switch in the second state of any one or more of Examples 1-14 optionally includes isolating the temperature output from the temperature sensor using the switch in the second state.

In Example 16, a system can include a mobile electronic device and a fuel gauge. The mobile device can include a battery configured to power the mobile electronic device. The battery can include a temperature sensor configured to provide battery temperature information, a charger configured to charge the battery, the charger including a temperature input configured to receive temperature information. The fuel gauge can a resistor configured to generate predetermined battery temperature information and a switch configured to couple the temperature sensor to the temperature input in a first state and to couple the resistor to the temperature input in a second state.

In Example 17, the switch of any one or more of Examples 1-16 optionally is configured to default to the first state when no power is applied to the fuel gauge.

In Example 18, the switch of ny one or more of Examples 1-17 optionally includes a depletion-mode transistor.

In Example 19, the fuel gauge of any one or more of Examples 1-18 optionally includes a control module configured to cycle the switch between the first state and the second state with a predetermined duty cycle.

In Example 20, the predetermined duty cycle of any one or more of Examples 1-49 optionally includes a. duty cycle of the first state that is at least twice a duty cycle of the second state.

In Example 21, a frequency of a cycle of the switch of any one or more of Examples 1-20 optionally is less than 2 Hertz.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to he illustrative, and not restrictive. For example, although the examples above have been described relating to PNP devices, one or more examples can be applicable to NPN devices, In other examples, the above-described examples (or one or more aspects thereof) may be used in combination with each other. Other embodiments can be used, such as by one of ordinary skill in the art upon reviewing the above description. The Abstract is provided to comply with 37 C,F,R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may tie in less than all features of a particular disclosed embodiment. Thus, the following claims are hereby incorporated into the Detailed Description, with each claim standing on its own as a separate embodiment. The scope of the invention should be determined with reference to the appended claims, along, with the hill scope of equivalents to which such claims are entitled.

What is claimed is:

1. A fuel gauge comprising:
a resistor configured to generate predetermined temperature information; and
a switch configured to couple a temperature sensor to a temperature output of the fuel gauge in a first state and to couple the resistor to the temperature output in a. second state,

2. The fuel gauge of claim 1, wherein the switch is configured to default to the first state when no power is applied to the fuel gauge.

3. The fuel gauge of claim 1, wherein the switch includes a transistor.

4. The fuel gauge of claim 1, wherein the switch includes a depletion-mode transistor.

5. The fuel gauge of claim 1, wherein the resistor includes a programmable resistor,

6. The fuel gauge of claim 1, including a temperature sense module having an input coupled to the switch and configured to receive information from the temperature sensor,

7. The fuel gauge of claim 6, including a bias resistor configured to provide a bias voltage to the temperature sense module.

8. The fuel gauge of claim 6, including a control module configured to cycle the switch between the first state and the second state with a predetermined duty cycle.

9. The fuel gauge of claim 1, wherein the switch is configured to isolate the temperature output from the temperature sensor in the second state.

10. A method of fuel gauge control, the method comprising:
coupling a temperature sensor to a temperature output of a fuel gauge using a switch in a first state;
generating predetermined temperature information using a resistor;
coupling the resistor to the temperature output of the fuel gauge using the switch in a second state; and
wherein the fuel gauge includes the switch and the resistor.

11. The method of claim 10, including defaulting the switch of the fuel gauge to the first state when no power is applied to the fuel gauge.

12. The method of claim 10, including receiving temperature information from the temperature sensor at a temperature sense module; and
wherein the fuel gauge includes the temperature sense module.

13. The method of claim 10, including cycling the switch between the first state and the second state with a predetermined duty cycle.

14. The method of claim 13, wherein the predetermined duty cycle includes a duty cycle of the first state that is at least twice a duty cycle of the second state.

15. The method of claim 10, wherein coupling the resistor to the temperature output using the switch in the second state includes isolating the temperature output from the temperature sensor using the switch in the second state.

16. A system comprising:
a mobile electronic device including:
a battery configured to power the mobile electronic device, the battery including a temperature sensor configured to provide battery temperature information;
a charger configured to charge the battery, the charger including a temperature input configured to receive temperature information; and
a fuel gauge, including:
a resistor configured to generate predetermined battery temperature information; and
a switch configured to couple the temperature sensor to the temperature input in a first state and to couple the resistor to the temperature input in a second state.

17. The system of claim 16, the switch is configured to default to the first state when no power is applied to the fuel gauge.

18. The system of claim 16, wherein the switch includes a depletion-mode transistor.

19. The system of claim 16, wherein the fuel gauge includes a control module configured to cycle the switch between the first state and the second state with a predetermined duty cycle.

20. The system of claim 19, wherein the predetermined duty cycle includes a duty cycle of the first state that is at least twice a duty cycle of the second state.

21. The system of claim 19, wherein a frequency of a cycle of the switch is less than 2 Hertz.
